(19) United States
(12) Patent Application Publication
(10) Pub. No.: US 2005/0079784 A1
(43) Pub. Date: Apr. 14, 2005

(54) Warp knit having an excellent touch, and a process of preparing the same

(75) Inventors: Joon Young Yoon, Busan-city (KR); Yoeng Beek Choi, Daegu-city (KR); Dae Hyun Cho, Daegu-city (KR)

Correspondence Address: SHANKS & HERBERT, 1301 K STREET, N.W., SUITE 1100 - EAST TOWER, WASHINGTON, DC, 20005, US

(73) Assignee: Kolon Industries, Inc.

(21) Appl. No.: 10/920,199

(22) Filed: Aug. 18, 2004

Related U.S. Application Data
(63) Continuation-in-part of application No. 09/856,314, filed on May 21, 2001, now abandoned.

(30) Foreign Application Priority Data
Sep. 19, 2000 (KR) 2000-54836
Sep. 19, 2000 (KR) 2000-54837
Dec. 16, 1999 (KR) 1999-58119
Nov. 30, 2000 (WO) PCT/KR00/01196

(51) Int. Cl. D04B 23/00; D04B 21/00; D04B 9/24; D04B 7/00; D04B 21/20; B32B 5/26; D04B 21/14; D04B 1/14; D04B 7/24

(52) U.S. Cl. 442/312; 442/304; 442/313; 442/308; 442/314; 442/318

(57) ABSTRACT

The present invention relates to a warp knit having excellent touch and a process of preparing such a warp knit. The present invention provides a warp knit consisting of a technical face, a rear face, and an intermediate spacer arranged between the technical face and the rear face, the technical face consisting of ultra fine yarn with monofilament denier of 0.01 to about 0.3 denier, the intermediate spacer consisting of spandex elastic yarn, and the rear face consisting of synthetic yarn with monofilament denier of 1 to about 5 denier, wherein the recovery rate of elongation in the directions of wale and course is 25 to about 60%. The warp knit according to the present invention can be used to manufacture artificial leathers or ladies' clothes.

This application is a continuation-in-part of U.S. patent application Ser. No. 09/856,314 filed May 21, 2001.

### FIELD OF THE INVENTION

The present invention relates to a warp knit having excellent touch and a process for preparing such a warp knit. More particularly, the present invention relates to a warp knit designed to be exquisitely soft and having such draping property as would make it useful for the manufacture of articles such as ladies' clothes and artificial leathers.

### BACKGROUND ART

Fine fibers tend to be soft to touch but also tend to have weak bending strength. Accordingly, there is active research aimed at developing commercial scale capabilities for the manufacture of fabrics comprising ultra fine fibers having very soft, sensitive touch. Development of technology capable of producing extremely fine synthetic yarns leads to great improvement in the value of the goods such as clothes comprising such sensitive materials.

Generally, the process of preparing ultra fine fiber is divided into three: a direct spinning process; a two-component division type spinning process; and a two-component extraction type spinning process. In the direct spinning process, it is possible to prepare ultra fine fiber of 0.3 to about 0.5 denier. In the two-component division type spinning process, it is possible to prepare ultra fine fiber of 0.2 denier or more. In the two-component extraction type spinning process, it is possible to prepare ultra fine fibers of 0.01 denier or less.

In the direct spinning process where the spinning and drawing are executed in a one-step process, the ultra fine fibers so prepared are warp knitted to very poor warping property and appearance since numerous filaments are scattered. Furthermore, the warp knit thus prepared is subjectively very inferior to touch and writing effect.

Furthermore, when ultra fine fibers consisting of nylon/polyester, prepared by means of the two-component division type composite spinning process, is warp knitted, warping and knitting properties of the warp knit is very poor since the nylon is isolated from the polyester as a result of the tension and friction in warping and knitting. Moreover, the appearance of the fabric is very poor due to denier limits of the ultra fine fiber.

On the other hand, when a composite fiber, such as nylon/polyester, of 0.05 denier or less prepared by means of the two-component extraction type spinning process is warp knitted, warping property, knitting property, and touch of the fabric are good. However, the density of the warp knit is adversely affected resulting in poor appearance since the extraction component is extracted at the extraction-processing step for producing the ultra fine fiber.

Generally, goods comprising ultra fine fiber are being produced in textile applications. However, in knitting applications, the poor warping property of ultra fine fibers and other processing drawbacks have limited the use of warp knitted ultra fine fibers.

Accordingly, it is an object of the present invention to prepare a warp knit comprising ultra fine fibers, with good warping and knitting properties, resulting in fabrics which have excellent touch, shape stability, and appearance, and thus suitable for materials such as ladies' clothes.

### SUMMARY OF THE INVENTION

The present invention provides yarns having good warping and knitting properties that can be warp knitted to produce a warp knit fabric that has excellent touch, shape stability, flexibility, and appearance, and is thus suitable for materials such as ladies' clothes; shape stability being the property of retaining the clothes' shape without change.

More particularly, the present invention relates to a warp knit having an intermediate face or spacer sandwiched between a technical face and a rear face. The technical face consisting of ultra fine yarn with mono-filament denier of 0.01 to about 0.3 denier, the intermediate spacer consisting of spandex elastic yarn, the rear face consisting of synthetic yarn or high shrinkage yarn with mono-filament denier of 1 to about 5 denier, wherein the recovery rate of elongation in the directions of wale and course is 25 to about 60%.

The present invention also relates to a process for preparing a warp knit fabric having excellent touch, comprising the steps of: knitting a composite fiber consisting of a fiber forming component of 0.01 to about 0.3 denier, and an extraction component, as the yarn of the technical face, a spandex elastic yarn as the yarn for the intermediate spacer, and a polyester yarn or high shrinkage yarn with mono-filament of 1 to about 5 denier as the yarn for the rear face. The warp knit fabric is then raised until the shrinkage rate of the warp knit has reached 40% or more, and then pre-heating the warp knit fabric, extracting the extraction component from the composite fiber, dyeing, buffing, and finally heat treating the warp knit, preferably in a Tenter Machine, to set the shape of the warp knit. It is understood by one of skill in the art that raising is done to improve both the appearance of the warp knit and to achieve a desired shrinkage rate.

### BRIEF DESCRIPTION OF THE DRAWINGS

The preferred embodiment of the present invention will now be described by way of example with reference to the accompanying drawings in which:

FIG. 1 is a graph showing recovery rate of elongation of a warp knit of the present invention measured using an Instron tester designed for testing the elongation and strength of a yarn or knit.

### DETAILED DESCRIPTION OF THE PREFERRED EMBODIMENTS

Reference will now be made in detail to the preferred embodiments of the invention. This invention may, however, be embodied in many different forms and should not be construed as limited to the embodiments set forth herein. In addition and as will be understood by one of skill in the art, the invention may be embodied as a product, method, system or process.

The selection and combination of materials in designing the structure of fabrics is very important in order to prepare polyester warp knit fabric which is as soft as natural suede, and which has excellent appearance as well as having excellent warping and knitting properties.

The present invention uses a composite fiber consisting of fiber-forming component of 0.01 to about 0.3 denier and an extracting component, as a yarn of the technical face. When the extraction component is removed from the composite fiber, the fiber-forming component with monofilament denier of 0.01 to about 0.3 denier is left. If the monofilament denier of the yarn of the technical face is more than 0.3 denier, its soft touch is poor and the writing effect is also poor to non-existent. If the monofilament denier of the yarn of the technical face is less than 0.01 denier, its soft touch is maintained, but its appearance is poor since raised fibers fall off the warp knit or are entangled due to friction.

WO 02/42528, assigned to Kolon Industries, Inc., describes the process of preparing composite fibers of the sea-island type used in preparing the ultra fine yarns of the technical face of the present invention. WO 02/42528 is hereby incorporated in its entire by reference.

The quantity of the extraction component in the composite fiber is generally 20 to about 40% by weight. It is preferable that polyester is used as the fiber-forming component and copolyester, with excellent alkali hydrolysis property, is used as the extraction component of the composite fiber.

It is preferable that the density of the yarn at the technical face is increased in order to improve the touch of the warp knit. It is possible for increasing the density of the yarn at the technical face to reduce the content of the extraction component in the composite fiber during the manufacturing phase of the composite fiber; however, the content of the extraction component is curbed technically during the spinning process. Spinning process refers to the standard process of extruding a melted polymer through a nozzle and drawing those for manufacturing yarns. There are limitations to increasing the density of the yarn of the technical face even if the content of the extraction component in the composite fiber is reduced.

For the purposes of this description, density refers to the number of fibers per inch of the warp knit and this term is expressed in terms of wales and courses per inch of the warp knit.

The present invention is further characterized in that spandex elastic yarn is used as the yarn of the intermediate spacer, whereby the yarn density of the technical face is increased by virtue of the shrinkage of the intermediate spacer. The spandex elastic yarn, which is a yarn of the intermediate spacer, has excellent shrinking property, and therefore increases the yarn density of the technical face of the finished warp knit, and provides good touch and flexibility to the warp knit. The total denier of the spandex elastic yarn is preferably between 30 and 90 denier.

Synthetic yarn with monofilament denier of 1 to about 5 denier, more preferably of polyester yarn or high shrinkage yarn, is used as the yarn for the rear face. If the monofilament denier of the yarn at the rear face is less than I denier, draping property of the warp knit is decreased. If the monofilament denier of the yarn at the rear face is more than 5 denier, warping property and knitting property of the warp knit are deteriorated. If the regular polyester yarn is used as the yarn of the rear face, mechanical stability and shape stability of the warp knit is improved. Preferably, polyester yarn of 50 denier/24 filament is used as the yarn of the rear face. The high shrinkage yarn has high shrinkage rate in boiling water, preventing the ultra fine yarn of the technical face from coming out of the rear face.

The high shrinkage yarn, which is used as the yarn of the rear face, preferably has a shrinkage rate in boiling water of 15 to about 50% at the stress of heat shrinkage of 0.2 grams/denier or more. If the shrinkage rate of the high shrinkage yarn in boiling water is less than 15%, it is not possible to increase the density of ultra fine yarn of the technical face, leading to poor touch. If the shrinkage rate of the high shrinkage yarn in boiling water is more than 50%, it is possible to increase the density of ultra fine yarn of the technical face; however, it is hard to control the process width of the finished warp knit since the shrinkage is extremely high.

Copolyester is preferably used as the high shrinkage yarn mentioned above. Co-polymer components include bisphenol-A, polyethyleneglycol, isophthalic acid-or the like. However, the present invention is not limited to any particular co-polymer component of the high shrinkage yarn.

The content of the yarn of the technical face when it is knitted is preferably 40 to about 87% by weight of the total weight of the processed warp knit. If the content of the yarn of the technical face is less than 40% in weight, the touch of the warp knit is poor. If the content of the yarn of the technical face is more than 87% by weight, the draping property and the mechanical property of the warp knit is deteriorates since the content of the yarn of the intermediate spacer and the yarn of the rear face is marginalized.

On the other hand, the content of the yarn of the intermediate spacer and the yarn of the rear face is preferably 3 to about 20% in weight and 10 to about 57% in weight of the total weight of the processed warp knit, respectively. If the content of the yarn of the intermediate spacer and the yarn of the rear face is more than the range mentioned above respectively, the touch of the warp knit is poor. If the content of the yarn of the intermediate spacer and the yarn of the rear face is less than the range mentioned above respectively, the shape stability and the draping property of the warp knit deteriorate.

The present invention is further characterized in that raw warp knit as mentioned above is raised so that the shrinkage rate of the raw warp knit is 40% or more before pre-heat treatment in a Tenter. Raising is carried out by means of a raising machine, at room temperature, and about eight passes in the raising machine would achieve a shrinkage rate of 40% or more.

Raising is the production of protruding fibers on the technical surface of the fabric by brushing. The fabric in open width, is passed between rotating rollers covered with teazels, fine wire, Carborundum, etc., whereby the surface fibers are pulled out or broken to give the required effect, such as suede effect, peach skin effect, etc.

The fabric finishing steps of the present invention typically involve raising, then preliminary heat-treatment, and further treatment in an alkali solution, whereby the extraction component is removed from the composite fiber. NaOH is the preferred alkali and extraction is carried out by immersing the fabric in the alkali solution at about 98 OC for about 30 minutes. After that, the warp knit is dyed, buffed and finally heat-treated. A second heat treatment may be carried out at 170° C. at 30 m/min in a Tenter and a final heat treatment may be carried out at 180-190° C. at 30 m/min.

It is preferable to maintain the density of the processed warp knit at 40 to about 80 wale/course number/inch so that excellent touch and shape stability is obtained.

The finishing operation is the final step in producing fabrics and typically imparts the aesthetic and physical properties required for various fabric uses. These properties, achieved through a combination of chemical and mechanical processes, include shrinkage control, stain resistance, water repellency, and softness. Conventional technologies may be used. In one embodiment, the raw warp knit is immersed in a solution of 1-2 wt % NaOH at 98° C. for 30 minutes in order to remove the extraction component. The length of exposure to NaOH depends on the desired weight reduction. If a lower temperature is desired, a 3-5 wt % NaOH may be used at 65° C. for 70 minutes. Once this is done, the fabric is removed and excess moisture is squeezed out mechanically. The moisture may be further reduced by a vacuum system before the fabric is directed to a fabric drying equipment such as a Tenter frame. The Tenter frame removes the remaining moisture by passing the fabric through a series of nozzles that expose it to hot air.

The preliminary heating, the fabric drying after alkali hydrolysis of the extraction component, and the final heating can all be Tenter processes. In one embodiment, an eight chamber Tenter process may be used under standard Tenter control conditions such as at the desired temperature at 30 m/min and fabric residence time of about 1 minute. For a four chamber Tenter, speed may be halved accordingly.

The warp knit of the present invention is composed of ultra fine yarn with monofilament denier of 0.01 to about 0.3 denier, whereby its touch and appearance are excellent as adjudged by a panel of experts. Especially, since the warp knit of the present invention includes an intermediate spacer consisting of spandex elastic yarn with excellent flexibility, the density of the ultra fine yarn at the technical face is higher, and the recovery rate of elongation of the warp knit in the directions of the wale and the course is 25 to about 60%. The recovery rate of elongation is basically affected by the degree of raising process, the shrinkage rate of the yarn of the rear face, the time and temperature of heat treatment. For instance, if the raising process is severe, the recovery rate of elongation increases because the severe raising process contracts the warp knit fabric.

Also, since the warp knit of the present invention includes a rear face consisting of yarn of regular synthetic yarn with monofilament denier of 1 to about 5 denier, the shape stability and the mechanical property of the warp knit are excellent.

A three-bar warp knitting process can be used to prepare the warp knit fabric of the present invention. For instance, the warp knit fabric of the present invention can be produced by feeding the ultra fine yarn wound on the first beam of the first feeding bar (L1), and the spandex elastic yarn wound on the second beam of the second feeding bar (L2), and the synthetic yarn wound on the third beam of the third feeding bar (L3) of the three bar warp knitting machine such that the yarn passing the L1 feeding bar constitutes the technical face, the yarn passing the L2 feeding bar constitutes the intermediate spacer and the yarn passing the L3 feeding bar constitutes the rear face, wherein the yarns of the three faces are bound together by a common knot.

The present invention is not limited to any knitting pattern. Any knitting pattern such that the ultra fine yarn constitutes the technical face and the spandex yarn constitutes the intermediate spacer and the high shrinkage yarn constitutes the rear face, with the raising and appropriate finishing steps falling within the scope of this invention will produce the exquisite touch and effect of the warp knit fabric of this invention.

As described in detail above, the warp knit of the present invention has excellent touch, appearance, flexibility, shape stability, and draping property as determined below, and thus it is suitable for materials for ladies' clothes or materials for artificial leathers.

The properties of the warp knit according to the present invention are evaluated as follows:

Softness

Softness of the warp knit is evaluated by sensitivity examinations of ten specialists. If more than eight specialists determine that the warp knit is soft, it is excellent. If five to about seven specialists determine that the warp knit is soft, it is good. If more than eight specialists determine that the warp knit is not soft, it is poor.

Draping Property

Draping property of the warp knit is evaluated by sensitivity examination of ten specialists. If more than eight specialists determine that the warp knit has draping property, it is excellent. If five to about seven specialists determine that the warp knit has draping property, it is good. If more than eight specialists determine that the warp knit has poor draping property, it is poor.

Writing Effect

Writing effect of the warp knit is evaluated by sensitivity examination of ten specialists. If more than eight specialists determine that the warp knit has writing effect, it is excellent. If five to about seven specialists determine that the warp knit has writing effect, it is good. If more than eight specialists determine that the warp knit has poor writing effect, it is poor.

Appearance

Appearance of the warp knit is evaluated by sensitivity examination of ten specialists. If more than eight specialists determine that the warp knit has good appearance, it is excellent. If five to about seven specialists determine that the warp knit has good appearance, it is good. If more than eight specialists determine that the warp knit has poor appearance, it is poor.

Shrinkage Rate in Boiling Water

Shrinkage rate in boiling water is measured according to JIS-L-1073 methods.

Recovery Rate of Elongation (%) of the Warp Knit Fabric.

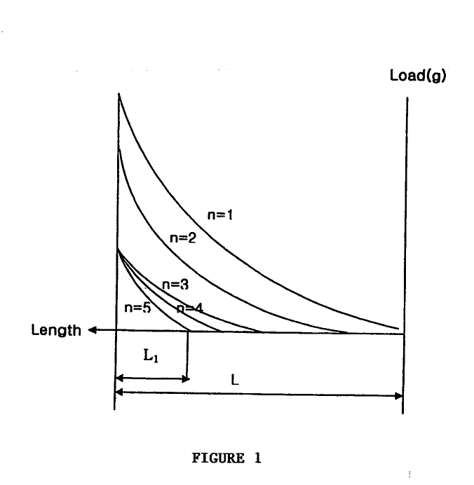

Total measurement is carried out according to KSK 08125, but proper elongation length at constant velocity is measured by using JIS L 1096. Both ends of a sample of the warp knit fabric with length of 10 cm and width of 15 cm are fixed to Instron. The warp knit is elongated constantly at the stretching velocity of 100 mm/min until a load of 750 g is reached. The warp knit is left as it is with the load being removed. Next, the warp knit is elongated at the constant velocity of 100 mm/min up to the original position. Then, the warp knit is left as it is for three minutes with the load being removed. The above process is repeated five times. Finally, the elongated length L, and the free elongated length L₁, are measured. The free elongated length L₁ is obtained by subtraction of the length measured after the warp knit is left as it is from the elongated length L (See FIG. 1). The recovery rate of elongation is obtained by putting the elongated length (L) and the free elongated length (L₁) in the following equation:
Recovery rate of elongation (%)=[elongated length (L)−free elongated length (L₁)]/elongated length (L)×100

Warping Property

Warping property is evaluated by checking the stop times/hour of the warping machine due to yarn defect. If the stop times/hour is zero, it is excellent. If the stop times/hour is one or two, it is good. If the stop times/hour is more than 3 times, it is poor. The stop times/hour of the warping machine is calculated by dividing the total stop times of warping machine in warping a yarn of 9kg by the total warping time.

Knitting Property

Knitting property is evaluated by checking the stop times/hour of the knitting machine due to yarn defect. If the stop times/hour is zero, it is excellent. If the stop times/hour is one or two, it is good. If the stop times/hour is more than 3 times, it is poor. The stop times/hour of knitting machine is calculated by dividing the total stop times of the knitting machine in a day by 24 hours.

Raising Property

The raising property of the warp knit is evaluated by sensitivity examination. If the raising of the warp knit is finished well by passing through the raising machine 8 times at speed of 15 m/minute, it is excellent. If the raising of the warp knit is finished well by passing through the raising machine 10 times at speed of 15 m/minute, it is good. If the raising of warp knit is finished well by passing through the raising machine more then 10 times at speed of 15 m/minute, it is poor.

The present invention is understood more concretely by comparison between examples of the present invention and comparative examples. However, the present invention is not limited to such examples.

### EXAMPLE 1

First, a raw warp knit having a density of 60 wales and courses/inch is prepared by using an extraction type composite fiber, wherein the fiber forming component is polyethylene terephtalate and the extraction component is copolyester copolymerized with 7 mole % dimethylene sulfrrisophthalic sodium, to yield 0.05 denier ultra fme yarn determined after removing the extraction component. This ultra fine yarn serves as the yarn for the technical face. For the intermediate spacer, spandex elastic yarn of 40 denier/5 filament is used as the yarn of the intermediate spacer and then polyester yarn with monofilament of 5 denier is used as a yarn for the rear face. The weight ratio of the yarn of the technical face to the yarn of the intermediate spacer to the yarn of the rear face is 55% to 10% to 35%. Next, the manufactured raw warp knit is passed through a raising machine until the shrinkage rate in boiling water of the warp knit has reached 50%. Next, the warp knit is pre-heated at 190° C., dipped in 1% NaOH solution for 30 minutes at 98° C. in order to remove the extraction component of the composite fiber. Finally, the processed warp knit is prepared by dyeing (with disperse dyes), buffing and heating at 180° C. at 30 meters/minute. After that, the properties of the processed warp knit are evaluated using the above-mentioned methods. The results of the evaluation are shown in Table 1.

### EXAMPLE 2

First, a raw warp knit having a density of 55 wales and courses/inch is prepared by using an extraction type composite fiber, wherein the fiber forming component is polyethylene terephtalate and the extraction component is copolyester copolymerized with 7 mole % of dimethylene sulfirisophthalic sodium, to yield 0.07 denier of ultra fine yarn determined after removing the extraction component. This ultra fine yarn serves as the yarn for the technical face. For the intermediate spacer, spandex elastic yarn of 40 denier/5 filaments is used and then polyester yarn with monofilaments of 3 denier is used as a yarn for the rear face. The weight ratio of the yarn of the technical face to the yarn of the intermediate spacer to the yarn of the rear face is 60% to 5% to 35%. Next, the manufactured raw warp knit is passed through a raising machine until the shrinkage rate in boiling water of the warp knit has reached 55%. Next, the warp knit is pre-heated at 190° C., dipped in 1% NaOH solution for 30 minutes at 98° C. in order to remove the extraction component of the composite fiber. Finally, the processed warp knit is prepared by dyeing (with disperse dyes), buffing and heating at 180° C. at 30 meters/minute. After that, the properties of the processed warp knit are evaluated using the above-mentioned methods. The results of the evaluation are shown in Table 1.

### EXAMPLE 3

First, a raw warp knit having a density of 60 wales and courses/inch is prepared by using an extraction type composite fiber, wherein the fiber forming component is polyethylene terephtalate and the extraction component is copolyester copolymerized with 7 mole % dimethylene sulfirisophthalic sodium, to yield 0.05 denier ultra fine yarn determined after removing the extraction component. This ultra fine yarn serves as the yarn for the technical face. For the intermediate spacer, spandex elastic yarn of 40 denier/5 filaments is used. Then copolyester yarn with monofilament of 5 denier and shrinkage rate in boiling water of 28% (high shrinkage yarn) is used as the yarn for the rear face. Weight ratio of the yarn of the technical face to the yarn of the intermediate spacer to the yarn of the rear face is 55% to 10% to 35%. Next, the manufactured raw warp knit is passed through a raising machine until the shrinkage rate in boiling water has reached 50%. Next, the warp knit is pre-heated at 190° C., dipped in 1% NaOH solution for 30 minutes at 98° C. in order to remove the extraction component of the composite fiber. Finally, the processed warp knit is prepared by dyeing (with disperse dyes), buffing and heating at 180° C. at 30 meters/minute. After that, the properties of the processed warp knit are evaluated using the above-mentioned methods. The results of the evaluation are shown in Table 1.

### EXAMPLE 4

First, a raw warp knit having the density of 55 wales and courses/inch is prepared by using an extraction type composite fiber, wherein the fiber forming component is polyethylene terephtalate and the extraction component is copolyester copolymerized with 7 mole % dimethylene sulfurisophthalic sodium, to yield 0.07 denier of ultra fine yarn determined after removing the extraction component. This ultra fine yarn serves as the yarn of the technical face. For the intermediate spacer, spandex elastic yarn of 40 denier/5 filaments is used and then copolyester yarn with monofilament of 3 denier and shrinkage rate in boiling water of 20% (high shrinkage yarn) is used as the yarn for the rear face. The weight ratio of the yarn of the technical face to the yarn of the intermediate spacer to the yarn of the rear face is 60% to 5% to 35%. Next, the manufactured raw warp knit is passed through a raising machine until the shrinkage rate in boiling water has reached 55%. Next, the warp knit is pre-heated at 190° C., dipped in 1% NaOH solution for 30 minutes at 98° C. in order to remove the extraction component of the composite fiber. Finally, the processed warp knit is prepared by dyeing (with disperse dyes), buffing and heating at 180° C. at 30 meters/minute. After that, the properties of the processed warp knit are evaluated using the above-mentioned methods. The results of the evaluation are shown in Table 1.

### COMPARATIVE EXAMPLE 1

First, a raw warp knit having a density of 60 wales and courses/inch is prepared by using an extraction type composite fiber, wherein the fiber forming component is polyethylene terephtalate and the extraction component is copolyester copolymerized with 7 mole % dimethylene sulfirisophthalic sodium to yield 0.05 denier ultra fine yarn determined after removing the extraction component. This ultra fine yarn serves as the yarn for the technical face. Polyester yarn with monofilament of 0.5 denier is used as a yarn for the rear face. At this time, weight ratio of the yarn of the technical face to the yarn of the rear face is 55% to 45%. Next, the warp knit is pre-heated at 190° C., dipped in 1% NaOH solution for 30 minutes at 98° C. in order to remove the extraction component of the composite fiber. Finally, the processed warp knit is prepared by dyeing (with disperse dyes), buffing and heating at 180° C. at 30 meters/minute. After that, the properties of the processed warp knit are evaluated using the above-mentioned methods. The results of the evaluation are shown in Table 1.

### COMPARATIVE EXAMPLE 2

First, a raw warp knit having a density of 60 wales and courses/inch is prepared by using an extraction type composite fiber, wherein the fiber forming component is polyethylene terephtalate and the extraction component is copolyester copolymerized with 7 mole % dimethylene sulfurisophthalic sodium, to yield 0.4 denier ultra fine yarn determined after removing the extraction component. This ultra fine yarn serves as the yarn of the technical face. Polyester yarn with monofilament of 0.5 denier is used as the yarn of the rear face. At this time, the weight ratio of the yarn of the technical face to the yarn of the rear face is 60% to 40%. Next, the manufactured raw warp knit is passed through a raising machine until the shrinkage rate in boiling water has reached 20%. Next, the warp knit is pre-heated at 190° C., dipped in 1% NaOH solution for 30 minutes at 98° C. in order to remove the extraction component of the composite fiber. Finally, the processed warp knit is prepared by dyeing (with disperse dyes), buffing and heating at 180° C. at 30 meters/minute. After that, the properties of the processed warp knit are evaluated using the above-mentioned methods. The results of the evaluation are shown in Table 1.

### COMPARATIVE EXAMPLE 3

First, a raw warp knit having a density of 60 wales and courses/inch is prepared by using an extraction type composite fiber, wherein the fiber forming component is polyethylene terephtalate and the extraction component is copolyester copolymerized with 7 mole % dimethylene sulfurisophthalic sodium, to yield 0.05 denier ultra fine yarn determined after removing the extraction component. This ultra fine yarn serves as the yarn for the technical face. Polyester yarn with monofilament of 10 denier is used as a yarn for the rear face. At this time, weight ratio of the yarn of the technical face to the yarn of the rear face is 55% to 45%. Next, the manufactured raw warp knit is passed through a raising machine until the shrinkage rate in boiling water has reached 55%. Next, the warp knit is pre-heated at 190° C., dipped in 1% NaOH solution for 30 minutes at 98° C. in order to remove the extraction component of the composite fiber. Finally, the processed warp knit is prepared by dyeing (with disperse dyes), buffing and heating at 180° C. at 30 meters/minute. After that, the properties of the processed warp knit are evaluated using the above-mentioned methods. The results of the evaluation are shown in Table 1.

### COMPARATIVE EXAMPLE 4

First, a raw warp knit having a density of 60 wales and courses/inch is prepared by using an extraction type composite fiber, wherein the fiber forming component is polyethylene terephtalate and the extraction component is copolyester copolymerized with 7 mole % dimethylene sulfurisophthalic sodium, to yield 0.05 denier of ultra fine yarn determined after removing the extraction component. This ultra fine yarn serves as the yarn for the technical face. Polyester yarn with monofilament of 0.5 denier is used as the yarn of the rear face. At this time, the weight ratio of the yarn of the technical face to the yarn of the rear face is 55% to 45%. Next, the manufactured raw warp knit is passed through a raising machine until the shrinkage rate in boiling water has reached 50%. Next, the warp knit is pre-heated at 190° C., dipped in 1% NaOH solution for 30 minutes at 98° C. in order to remove the extraction component of the composite fiber. Finally, the processed warp knit is prepared by dyeing (with disperse dyes), buffing and heating at 180° C. at 30 meters/minute. After that, the properties of the processed warp knit are evaluated using the above-mentioned methods. The results of the evaluation are shown in Table 1.

### COMPARATIVE EXAMPLE 5

First, a raw warp knit having a density of 60 wales and courses/inch is prepared by using an extraction type composite fiber, wherein the fiber formation component is polyethylene terephtalate and the extraction component is copolyester copolymerized with 7 mole % of dimethylene sulfurisophthalic sodium, to yield 0.05 denier of ultra fine yarn determined after removing the extraction component. This ultra fine yarn is used as the yarn for the technical face. Polyester yarn with monofilament of 10 denier is used as the yarn for the rear face. At this time, the weight ratio of the yarn of the technical face to the yarn of the rear face is 55% to 45%. Next, the manufactured raw warp knit is passed through a raising machine until the shrinkage rate in boiling water has reached 55%. Next, the warp knit is pre-heated at 190° C., dipped in 1% NaOH solution for 30 minutes at 98° C. in order to remove the extraction component of the composite fiber. Finally, the processed warp knit is prepared by dyeing (with disperse dyes), buffing and heating at 180° C. at 30 meters/minute. After that, the properties of the processed warp knit are evaluated using the above-mentioned methods. The results of the evaluation are shown in Table 1.

TABLE 1
Results of property evaluation of warp knit

| | | | | | Recovery rate of | |
|---|---|---|---|---|---|---|
| | | | | | elongation (%) | |
| | | | | | In the | In the |
| | | Draping | Witting | | direction | direction |
| Class | Softness | Property | effect | Appearance | of wale | of course |
| Example 1 | Excellent | Excellent | Excellent | Excellent | 41.9 | 37.6 |
| Example 2 | Excellent | Excellent | Excellent | Excellent | 35.7 | 32.8 |
| Example 3 | Excellent | Excellent | Excellent | Excellent | 42.2 | 38.7 |
| Example 4 | Excellent | Excellent | Excellent | Excellent | 36.1 | 33.5 |
| Comparative | Good | Poor | Excellent | Good | 20.0 | 18.6 |
| Example 1 | | | | | | |
| Comparative | Poor | Excellent | Poor | Good | 15.9 | 17.2 |
| Example 2 | | | | | | |
| Comparative | Poor | Excellent | Excellent | Good | 10.4 | 13.0 |
| Example 3 | | | | | | |
| Comparative | Good | Poor | Excellent | Good | 20.2 | 18.6 |
| Example 4 | | | | | | |
| Comparative | Poor | Excellent | Excellent | Good | 10.4 | 13.0 |
| Example 5 | | | | | | |

As described above, the warp knit according to the present invention has excellent touch, appearance, elastic recovery rate, draping property, and thus is useful for materials of artificial leathers or ladies' clothes.

1. A warp knit consisting of three layers: namely a technical face, a rear face, and an intermediate spacer arranged between the technical face and the rear face, the technical face consisting of ultra fine yarn with monofilament denier of 0.01 to about 0.3 denier, the intermediate spacer consisting of spandex elastic yarn, the rear face consisting of synthetic yarn with monofilament denier of 1 to about 5 denier, wherein the recovery rate of elongation in the directions of wale and course is 25 to about 60%.

2. The warp knit of claim 1, wherein the content of the ultra fine yarn constituting the technical face is 40 to about 87% in weight of the total weight of the processed warp knit.

3. The warp knit of claim 1, wherein the content of the spandex elastic yarn constituting the intermediate spacer is 3 to about 20% in weight of the total weight of the processed warp knit.

4. The warp knit of claim 1, wherein the content of the synthetic yarn constituting the rear face is 10 to about 57% in weight of the total weight of the processed warp knit.

5. The warp knit of claim 1, wherein the density of the processed warp knit is 40 to about 80 wales and courses/inch.

6. The warp knit of claim 1, wherein the ultra fine yarn and the synthetic yarn are polyester yarns.

7. The warp knit of claim 1, wherein the synthetic yarn is a co-polyester yarn with 15 to about 50% shrinkage rate in boiling water.

8. A process of preparing a warp knit comprising the steps of:
knitting the warp knit by using a composite fiber comprising a fiber forming component of 0.01 to about 0.3 denier and an extraction component, as the yarn for the technical face, a spandex elastic yarn as the yarn for an intermediate spacer, and a polyester yarn with monofilament of 1 to about 5 denier as the yarn for the rear face,
and then raising the warp knit until a 40% or more shrinkage rate of the warp knit in boiling water is reached,
and then pre-heating, extracting the extraction component from the composite fiber, dyeing, buffing,
and finally heat treated.

9. The process of claim 8, wherein the weight ratio of the yarn of the technical face to the yarn of the intermediate spacer to the yarn of the rear face is 40 to about 87% to 3 to about 20% to 10 to about 57%.
